(19) United States
(12) Patent Application Publication
(10) Pub. No.: US 2009/0120106 A1
(43) Pub. Date: May 14, 2009

(54) Temperature Alert Device for Cryopreservation

(76) Inventor: Milton Chin, Trumbull, CT (US)

Correspondence Address: MARK S. NOWOTARSKI, 30 GLEN TERRACE, STAMFORD, CT, 06906, US

(21) Appl. No.: 12/268,016

(22) Filed: Nov. 10, 2008

Related U.S. Application Data
(63) Continuation-in-part of application No. 12/267,794, filed on Nov. 10, 2008.
Application No. 12/267,794 is a continuation-in-part of application No. 12/267,708, filed on Nov. 10, 2008.
(60) Provisional application No. 60/987,110, filed on Nov. 12, 2007.

(51) Int. Cl. F17C 13/02; G01K 5/48

(52) U.S. Cl. 62/49.1; 374/187; 374/E05.03

(57) ABSTRACT

A temperature alert device to warn of imminent devitrification due to warming of a biological specimen that uses shape memory materials. The temperature induced phase transformation of shape memory materials causes a temperature responsive actuator to extend an alert rod upon warming as the specimen temperature approaches the devitrification temperature (e.g. −130° C.). The temperature alert device is automatically reset upon immersion in liquid nitrogen.

### CROSS-REFERENCE TO RELATED APPLICATIONS

This application is a continuation in part of U.S. nonprovisional patent application Ser. No. 12/267,794 filed on Nov. 10, 2008 entitled “Vitrification Device with Shape Memory Seal”. Said nonprovisional application is incorporated herein by reference.

Said U.S. nonprovisional patent application Ser. No. 12/267,794, in turn, is a continuation in part of U.S. nonprovisional patent application Ser. No. 12/267,708, filed on Nov. 10, 2008 entitled “Shape-Shifting Vitrification Device”. Said nonprovisional application is incorporated herein by reference.

Said nonprovisional patent application Ser. No. 12/267,708, in turn, claims priority to U.S. provisional patent application entitled “Shape Memory Vitrification Cryocontainer”, Ser. No. 60/987,110 filed on Nov. 12, 2007. Said provisional application is incorporated herein by reference.

### TECHNICAL FIELD

This invention is in the field of devices for the cryopreservation of biological specimens.

### BACKGROUND

Cryopreservation is practiced in the life sciences for the purpose of halting biological activity in valuable cell(s) for an extended period of time. One factor in the success of cryopreservation is reducing or eliminating the deleterious effect of ice crystal formation. Sophisticated methods are needed to thwart the natural tendency of water to freeze into ice during cryopreservation.

### Cryopreservation

One method of minimizing ice crystal formation is called “slow-freeze.” The initial step in slow-freeze is to dehydrate a cell or cells with an aqueous solution (“slow-freeze media”) containing permeating and non-permeating cryoprotectants (“CPA”). The cell or cells, together with a small quantity of slow-freeze media, comprise the “biological specimen.” The biological specimen is then placed in a suitable cryocontainer, i.e. a container suitable for use at cryogenic temperatures. As used herein, “cryogenic temperatures” means temperatures colder than −80° C. Slow-freeze cryopreservation entails chilling the biological specimen from room temperature to its ultimate cryogenic storage temperature that is typically −196° C., the atmospheric boiling point of liquid nitrogen (“LN2”). For a portion of this temperature range, from approximately −6° C. down to −30° C., the chilling rate is precisely controlled to 0.1-0.3° C./minute by a programmable freezer. Chilling from −30° C. to −196° C. is achieved by plunging the cryocontainer in LN2. Slow-freeze processes take 2-3 hours to complete, hence the name. By this process, ice crystals do form in the CPA surrounding the cell or cells, and minimally within the cell or cells. Slow-freeze is effective in cells with low water content, such as embryos and sperm, but does not perform as well in high water content cells, such as oocytes and blastocysts. This deficiency, high equipment cost, and the high consumption of time have lead to the development of an alternative cryopreservation method called vitrification.

### Vitrification

Vitrification differs from slow-freeze in that it seeks to avoid the formation of cell-damaging ice altogether. Similar to slow-freeze, the first step in vitrification is to dehydrate the cell or cells as much as possible using CPA containing fluids called “vitrification media”. The biological specimen (same definition as slow-freeze) is then rapidly chilled by immersion in a cryogenic fluid such as LN2. With a proper combination of chilling speed and CPA concentration, intracellular water will attain a solid, innocuous, glassy (vitreous) state rather than an orderly, damaging, crystalline ice state. Vitrification can be described as a rapid increase in fluid viscosity that traps the water molecules in a random orientation. Vitrification media, however, contain higher levels of CPA than slow-freeze media and are toxic to cells except in the vitreous state. Therefore, the time exposure of cells to vitrification media during dehydration and thawing (called “warming” since ice is not formed) must be carefully controlled to avoid cellular injury. The end point of vitrification and slow-freeze is the same: long term storage in a cryogen such as LN2.

If a chilling speed of 106° C./minute were possible, vitrification could be achieved with no cryoprotectants at all. Extremely toxic vitrification media, with 60% w/w CPA concentration, can be vitrified with ordinary chilling speed. Commercial vitrification media have CPA formulations and minimum enabling chilling speeds between these boundaries. The inverse relationship between CPA concentration and minimum enabling chilling speed is well known. The key to minimizing the toxic effects of vitrification media is to minimize its CPA concentration. Therefore, it is desirable to chill quickly; the faster the better. Given this, a natural initial discovery in this field was to directly plunge the biological specimen into LN2 to achieve rapid chilling. Carrier devices to enable direct plunge were created to facilitate and control this process. Examples are: electron microscopy grids, open pulled straws, Cryoloop™, nylon mesh, and Cryotop. Cryoloop is a trademark of Hampton Research. These devices are classified as “open carriers” in that the biological specimen is in direct contact with the chilling cryogen, typically LN2. Open carriers also enabled rapid warming of the biological specimen.

LN2, however, is not aseptic. It may contain bacterial and fungal species, which are viable upon warming. Furthermore, it has been reported that vitrified cells held in long term storage in LN2 could be infected by viral pathogens artificially placed in said LN2. Hence, there is the potential for infection of biological samples vitrified in open carriers. The potential of infection has lead to the development of closed cryocontainers where the biological sample is placed in a cryocontainer and sealed before chilling in LN2. The cryocontainer also serves as a storage device to isolate it from pathogen-containing cryogen during long-term storage in LN2 tanks.

Once a biological specimen is vitrified, harmful ice formation cannot occur. Storing a vitrified biological specimen in LN2 at −196° C. maintains this safe state. However, if the biological specimen in inadvertently warmed to above the glass transition temperature (“T_{g}”) of the vitrification media, devitrification can occur. For vitrification media, T_{g} is thought to be about −130° C. as this is the T_{g} for water. Devitrification leads to unwanted damaging ice crystal formation. From time to time, vitrification cryocontainers are taken out of LN2 tanks for various reasons and then returned to the LN2 tank. If during this excursion, the temperature of the biological specimen rises above T_{g}, there is a risk of devitrification. Therefore, it is vital to know if the temperature of the biological specimen during these out-of-the-tank excursions warms above T_{g}. If it warms too close to T_{g}, the cryocontainer needs to be placed back into the LN2 to re-equilibrate to −196° C.

### Limitations of Current Cryocontainers for Vitrification

U.S. Pat. No. 7,316,896, “Egg freezing and storing tool and method”, (“the '896 device”) describes a closed cryocontainer for vitrification. This device comprises a fine plastic tube (nominally 0.25 mm OD and a wall thickness of 0.02 mm). A typical biological specimen will contain a human oocyte that is dehydrated with vitrification media and then drawn into the tube. Then both ends of the tube are heat-sealed with a thermal sealing device to create an aseptic container.

US Patent Application 2008/0220507, “Kit for packaging predetermined volume of substance to be preserved by cryogenic vitrification”, (“the '507 device”) describes a tube-within-a-tube closed cryocontainer concept. Both tubes are fabricated from plastic. The inner tube is modified to create a channel at one end upon which the biological specimen is placed. The loaded inner tube is then placed within the outer tube. The outer tube is then heat-sealed at the loading end to create an aseptic cryocontainer.

International Patent Application WO 07/120829, “Methods of the cryopreservation of mammalian cells”, (“the '829 device”) describes the use of ultrafine tubes for vitrification. One embodiment of the '829 device is an ultrafine microcapillary quartz tube. Biological specimens can be drawn into such a device and vitrified. Due to the exceedingly thin wall sections (10 microns) and high thermal conductivity of quartz as compared to plastics, the inventors claim that the '829 device will have high (greater than 30,000° C./minute) chilling rate.

US Patent Application 2008/0038155, “Tool and method for manipulating a sample of developmental cells in a process of cryopreservation”, (“the '155 device”) describes a tubular vitrification carrier with a cantilevered section. The biological specimen is placed on the cantilever section and a tubular protective sleeve then placed over the carrier.

The '896, '507, and '829 devices are examples of closed vitrification cryocontainers. The '155 device is an example of an open vitrification cryocontainer. After loading, all achieve vitrification by being plunged into LN2. During long-term storage, they may be taken out of LN2 and be at risk for devitrification due to an inattentive user. None of these devices include a temperature alert feature that alerts the user to a cryocontainer that has warmed to a dangerous temperature.

### Limitations of Current Shape Memory Temperature Alert Devices

The relationship of shape to temperature of shape memory materials has been utilized in the prior art in various temperature monitoring devices. U.S. Pat. No. 4,448,147, “Temperature Warning Device”, (“the '147 device”) proposes a real time over-temperature device fabricated from shape memory materials. The '147 device is designed for current-carrying electrodes where, presumably, conventional thermometers will not work. The '147 Device uses a shape memory alloy that is limited to shape memory transforms at temperatures greater than −100° C.

US Patent Application 2008/0215037, “Temperature Responsive Systems”, (“the '037 device”) is a shape memory device that alerts the user if a predetermined temperature has been reached. At this predetermined temperature, the shape memory device breaches a container to release a substance. The released substance, in various ways, alerts the user. One way is for the released substance to be combined with another substance to provide a visual alert due to a color change. Another way is for the released substance to be odoriferous, and smelling the odor is the alert.

Neither of the above described shape memory devices temperature alert devices function at temperatures below −100° C. A devitrification alert device must function below this temperature. Furthermore, it is desirable to provide a means to reset the temperature alert device when it is placed back into LN2 and re-equilibrates to −196° C. Neither of the shape memory temperature sensing devices have this feature.

### SUMMARY OF THE INVENTION

The Summary of the Invention is provided as a guide to understanding the invention. It does not necessarily describe the most generic embodiment of the invention or all species of the invention disclosed herein.

The present invention comprises a vitrification cryocontainer (closed or opened) that includes a temperature alert device. The temperature alert device utilizes the unique material characteristics of shape memory materials to provide a visual alert to the user of a devitrification risk due to sample warming.

### BRIEF DESCRIPTION OF DRAWINGS

FIG. 1 is a diagram that shows the relationship between the crystallographic state of a shape memory material exhibiting one-way shape memory and temperature.

FIG. 2 is a diagram that shows the relationship between the crystallographic state of a shape memory material exhibiting two-way shape memory and temperature.

FIG. 3 illustrates an actuator made by joining a shape memory material and non-shape memory bias spring.

FIG. 4 illustrates an actuator comprised of two-way shape memory materials

FIG. 5 illustrates the features of a cryocontainer and a temperature alert device.

FIG. 6 shows the features of a loaded cryocontainer attached to a temperature alert device.

FIG. 7 shows a cryocontainer inspection process that utilizes the temperature alert device.

FIG. 8 shows a temperature alert device configured for use with an RFID tag.

### DETAILED DESCRIPTION

The following detailed description discloses various embodiments and features of the invention. These embodiments and features are meant to be exemplary and not limiting.

As used herein, unless with reference to temperature or unless specifically indicated otherwise, the term “about” means within ±20% of a given value. With reference to temperature, the term “about” means within ±2° C. of a given value.

A variety of biological cells can be aseptically cryopreserved (vitrified) using the present invention. One category of cells is mammalian developmental cells such as sperm, oocytes, embryos, morulae, blastocysts, and other early embryonic cells. These cells are routinely cryopreserved during assisted reproduction procedures. Another category is stem cells that are used in regenerative therapies. The broadest category is any cell that can be vitrified using a vitrification media that aligns with the available chilling speed of this invention.

### Shape Memory Effect

The shape memory effect exists in alloys of certain metals such as Ag—Cd, Au—Cd, Cu—Al—Ni, Cu—Zn—Al, Cu—Zn—Si, Cu—Zn—Sn, Cu—Sn, Cu—Zn, Fe—Pt, Fe—Mn—Si, In—Ti, Mn—Cu, Mn—Si, Ni—Ti, Ni—Al, and others. Of this group, alloys of Ni—Ti are the most commercially prevalent variant and are referred to as nitinol. This invention can be implemented by a wide variety of shape memory alloys. The specific alloy to be use can be selected by those skilled in the art. To facilitate the understanding of this invention, the properties of nitinol as the shape memory material will be used in this Description to illustrate the features of this invention.

The shape memory effect is a phenomenon in which an object can exist in two different crystallographic states. The shape memory effect can be characterized as “one-way” or “two-way”. In one-way shape memory materials, an object in the first, higher temperature state is rigid with a unique defined “memorized” shape. Upon cooling, this object changes to a readily deformable state. The object can be made to lose its deformability and metamorphose back to its unique defined shape by heating the material. Materials science teaches us that shuttling between these physical states is a phenomenon caused by a temperature induced phase change of the material.

In two-way shape memory materials, the lower temperature phase is rigid instead of malleable and has its own memorized shape. Thus an object made from a two-way shape memory material can be toggled between two different shapes by increasing or decreasing the temperature of the object such that it alternates between the high temperature and low temperature phase.

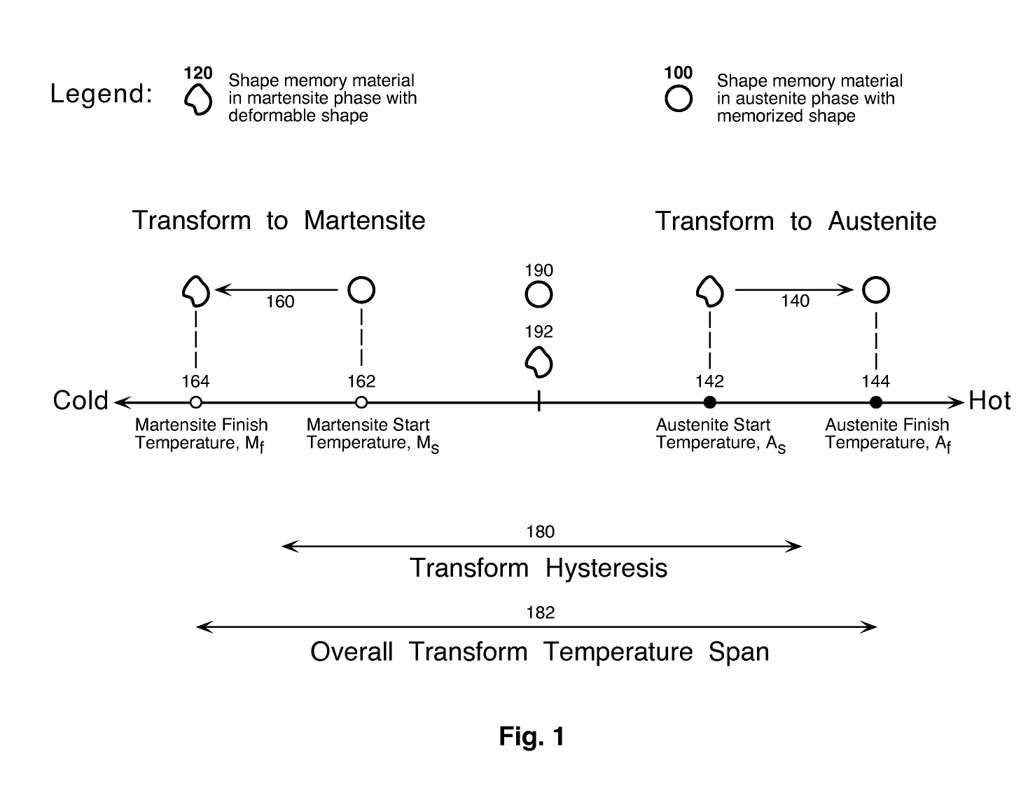

FIG. 1 is a temperature-induced shape memory phase change diagram showing the behavior of “one-way” shape memory material. One-way shape memory materials exist in two crystallographic structures: austenite (icon 100) and martensite (icon 120). The austenite phase is characterized by stiffness and superelastic properties. The martensite phase is soft and malleable. The shape of an austenite object is referred to as the “memorized shape.” An object in the austenite phase can be transformed into martensite by cooling. As soft martensite, the object can then be deformed. This martensite object can be transformed back into austenite by heating. Upon this phase conversion, the object's shape will return (with some force) to the “memorized shape”.

The martensite to austenite transform 140 occurs over a range of temperatures from Aₛ (austenite start) 142 to A_{f}, (austenite finish) 144. Similarly, the austenite to martensite transform 160 occurs over a range of temperatures from Mₛ (martensite start) 162 to M_{f}, (martensite finish) 164. Austenite transform and martensite transform occur within different transform temperature bands. This phenomenon is called transformation hysteresis 180 which is the temperature spread between an object that is 50% transformed to austenite upon heating and an object that is 50% transformed back to martensite upon cooling. The overall transform temperature span 182 signifies the temperature range one needs to transform an object between 100% martensite and 100% austenite. For nitinol, the overall transform temperature span is approximately 50° C. A typical transform temperature band is 15-20° C. An important characteristic of shape memory materials is that an object can either be in its austenite phase 190 or martensite phase 192 when its temperature is between the transform temperature bands, depending upon its history of heating and cooling.

With nitinol, the transformation temperatures 142,144,162, and 164 are determined by the Ni to Ti atomic ratio and the metallurgical processing of the nitinol after alloy formation. Nitinol's austenite memorized shape is configured by metallurgical processing when the material is in its austenite phase.

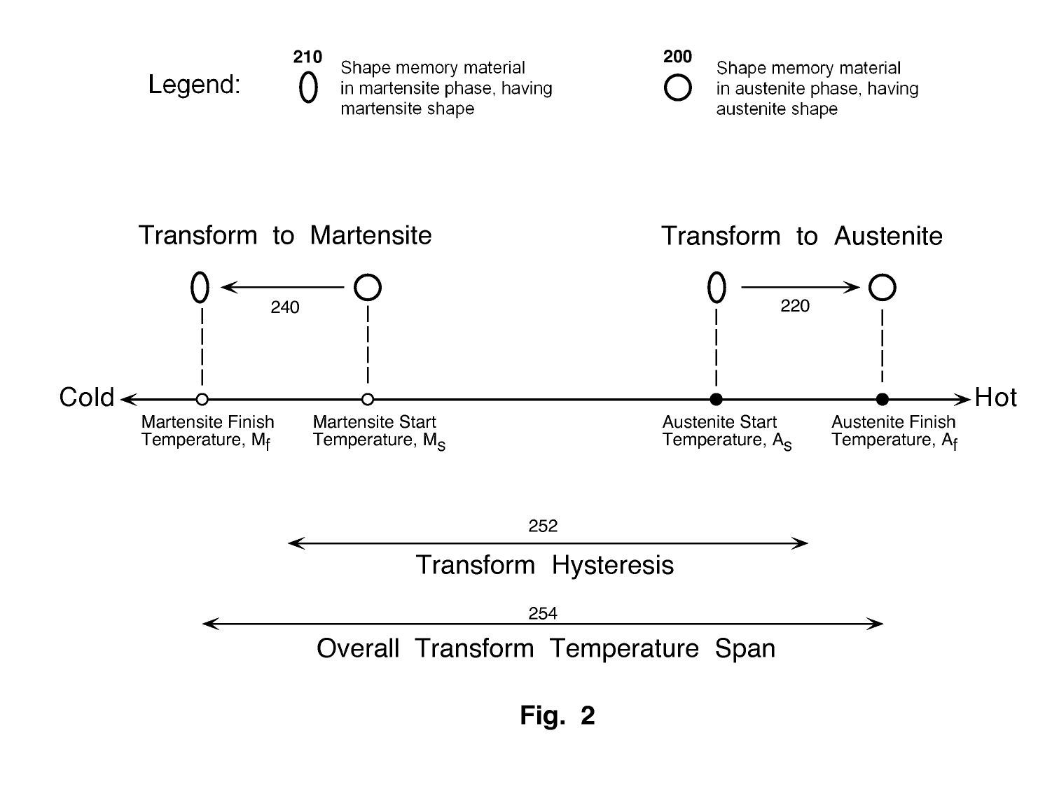

FIG. 2 is a temperature-induced shape memory phase change diagram for shape memory materials that exhibit two-way shape memory. Most shape memory materials that exhibit one-way shape memory can be trained to exhibit two-way shape memory. These materials exist in two crystallographic structures: austenite (icon 200) and martensite (icon 210). Objects fabricated from two-way shape memory materials will have two unique shapes depending on the phase. An austenite object is referred to as having the “austenite shape”. The shape of a martensite object is referred to as the “martensite shape”. Both shapes are firm and distinct. There are two “memorized shapes” in two-way shape memory versus one for one-way shape memory. The temperature transforms 220 and 240 toggle the shape memory material between the phases and result in shape changes. Transform hysteresis 252 and overall transform temperature span 254 have a similar meaning as for one-way shape memory materials.

### Temperature Responsive Shape Memory Actuators

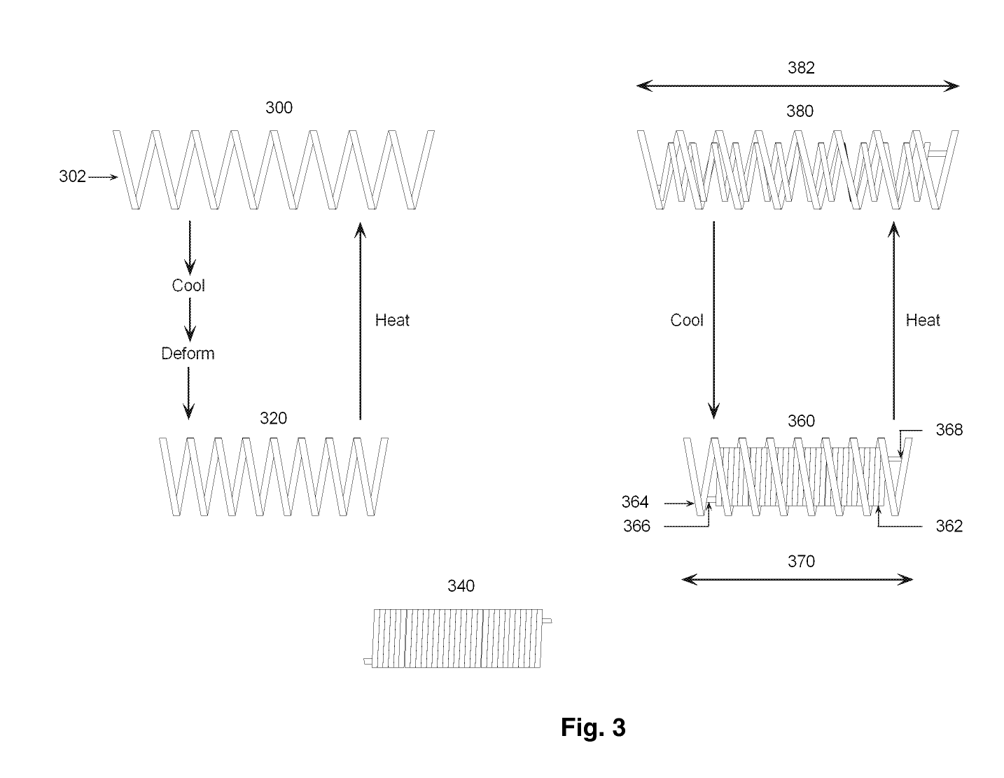

FIG. 3 illustrates the use of one-way shape memory materials to make a temperature responsive actuator. Item 300 is a helical nitinol spring in its austenite phase and hence its memorized shape. Within the spring is an open cylindrical space 302 that will be used to receive a bias spring as discussed below. If the nitinol spring is cooled and transformed to martensite, it can be compressed to a shorter length 320 and will remain compressed if compressive forces are removed. If the nitinol spring is heated to invoke its austenite transform, its shape is restored to the memorized shape and the spring expands (item 300).

Item 340 shows a normally compressed helical bias spring that is fabricated from a conventional spring material such as steel, brass, aluminum, or other non-shape memory material.

Referring to item 360, if a bias spring 362 is nested within a nitinol spring 364 (or vice versa) and the ends 366, 368 of each are joined, a temperature responsive actuator is formed. If the nitinol spring is in its martensite phase, the actuator will be collapsed to a short length 370 by the bias spring. If the actuator is heated above the austenitic finish temperature, the nitinol spring will expand and the actuator 380 will expand to a long length 382.

The transformation from a short length to a long length will proceed incrementally as the actuator is heated from its austenite start temperature to its austenite finish temperature. Thus upon heating, the length of the actuator can be calibrated to a temperature between Aₛ and A_{f}. The actuator can be reset to its short length by cooling below its martensite finish temperature. Thus the actuator can be used to monitor temperature repeatedly during alternate warming and cooling cycles.

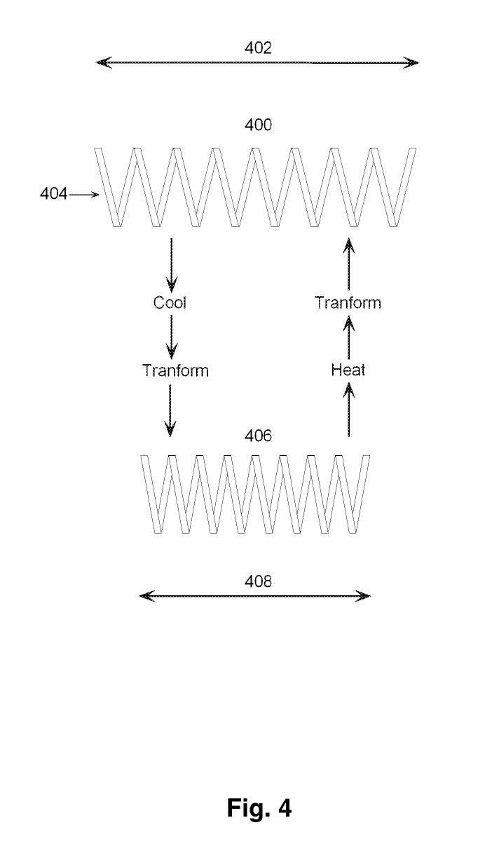

FIG. 4 illustrates the use of two-way shape memory materials to make a temperature responsive actuator. Item 400 is a two-way nitinol spring in its austenite shape having a relatively long length 402. Within the spring is an open cylindrical space 404. Cooling the austenite spring to below its martensite finish temperature invokes its martensite transform. This results in the spring morphing into its martesite shape 406, having a relatively short length 408. If the spring is then heated to above its austenite finish temperature, its length reverts back to its long length.

### Temperature Alert Device for Cryopreservation

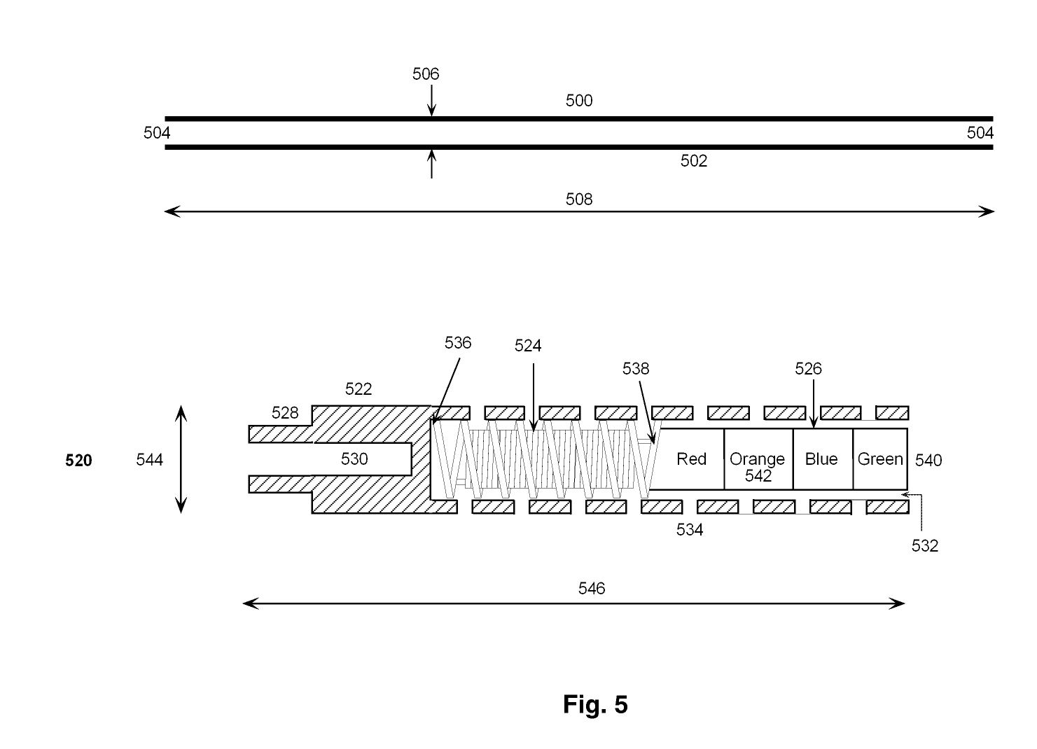

FIG. 5 illustrates an application of a temperature alert device on a cryocontainer to alert the user of a devitrification risk. Longitudinal sections of generally tubular elements of an exemplary cryocontainer 500 with the temperature alert device 520 are shown. The cryocontainer comprises a tube 502 with two open ends 504. An OD 506 of about 2 mm and a length 508 of 3-6 cm are suitable.

Temperature alert device 520 comprises a cylindrical base 522, a shape memory actuator 524, and an alert rod 526. As used herein, “rod” may mean any physical indicator, such as a tab or cylinder, that can be attached to or operatively engaged with (e.g. attached to) the shape memory actuator. The cylindrical base comprises a shoulder 528, counterbore 530, chamber 532, and slots 534. The actuator is attached to the cylindrical base at 536 and to the alert rod at 538. Both the actuator and alert rod are free to move substantially linearly within the chamber. Transform motion of the actuator due to warming or cooling telescopically extends or withdraws the alert rod relative to exit 540. This urging out or in can be fairly forceful. Slots function to expose the actuator to the environment and increase the heat transfer thereto. The number and dimensions of the slots are selected to maximize heat transfer without compromising structural integrity. The alert rod comprises an exterior surface with bands of alert colors 542. An OD 544 of 0.5-1 cm is suitable. A length 546 of 3-8 cm is suitable.

The alert colors can correspond to increasing threats of devitrification. Green might correspond to a first indication at about −150° C. Blue and orange would correspond to increasing intermediary indications above about −150° C. Red would correspond to a final indication at about −130° C.

An exemplary alert protocol to warn of devitrification is to identify a “devitrification threshold temperature.” Below this temperature, the biological specimen is relatively safe. Above it, the risks of devitrification increase rapidly. A natural devitrification threshold temperature is about −130° C., the glass transition temperature of water. Vitrification media may have a slightly different devitrification threshold temperature. The shape memory actuator comprises a one-way shape memory spring and a bias spring. The shape memory spring has an austenite start temperature of about −150° C. or colder. The actuator will commence to extend at this temperature and continue to extend until the austenite finish temperature is reached. Preferably, the austenite finish temperature is the devitrification threshold temperature, about −130° C.

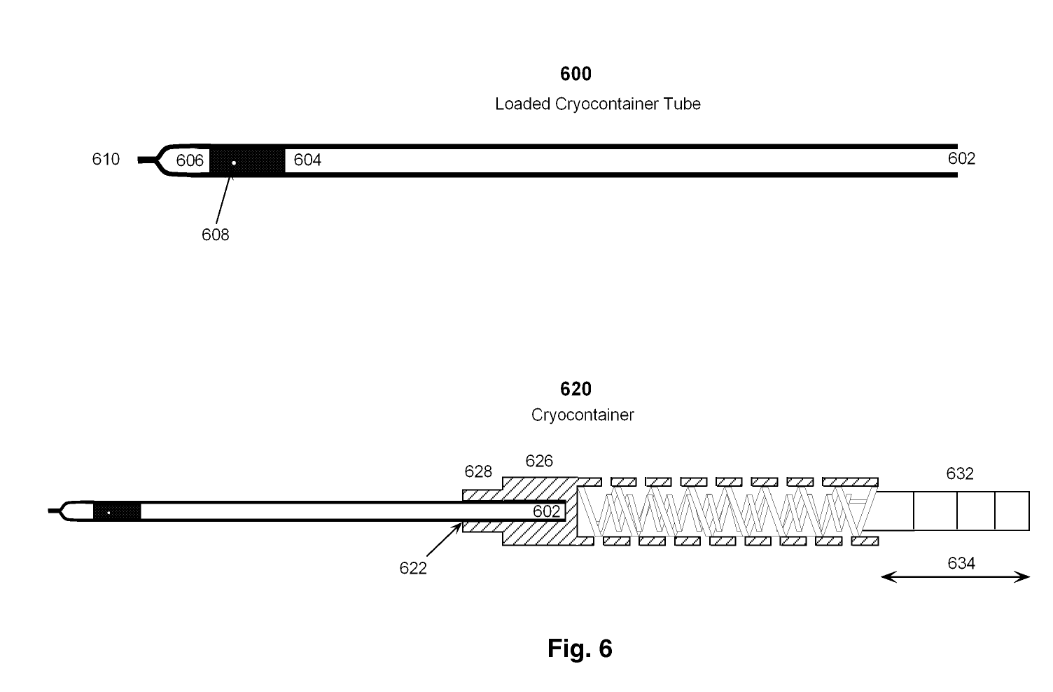

FIG. 6 shows a process to load and assemble a cryocontainer tube 600 with the temperature alert device. Prior to sealing end 610, a syringe (not shown) was attached to opening 602 of the cryocontainer tube. The syringe created a vacuum that drew biological specimen 604 into the other end of the cryocontainer tube. A biological specimen comprised vitrification media 606 and one or more cells, 608 that are to be cryopreserved. The end of the cryocontainer tube with the biological specimen was then heat sealed to create aseptic seal 610.

After loading and sealing, and referring to item 620, the open end 602 of the cryocontainer tube is then placed within the counterbore 622 of the cylindrical base 626. An aseptic seal is created by heat-sealing at shoulder 628. The alert rod 632 of the alert device is extended out of the opening by reveal length 634 since loading is done at room temperature, well above the nitinol spring's austenite finish temperature. A suitable reveal length is about 1.5 cm.

The cryocontainer is then placed in liquid nitrogen and the biological specimen is vitrified. The alert rod fully withdraws since the nitinol spring is transformed below its martensite finish temperature. If the cryocontainer is removed from the liquid nitrogen and begins to warm, then the nitinol spring will extend, the alert rod will extend and a warning of imminent devitrification will be provided. If the cryocontainer is returned to the liquid nitrogen bath, the alert rod will then withdraw.

### Suitable Nitinol Grades for Temperature Alert Device

When a cryocontainer is taken out of LN2 (−196° C.) storage and warms, the risk of devitrification starts at the T_{g} of water which is about −130° C. An alert protocol should initiate the alert at a safe (between −196 and −130° C.) temperature and provide increasingly stronger warnings culminating at about −130° C. An actuator has transform motion from its austenite start temperature to its austenite finish temperature. Therefore, a suitable austenite start temperature is about −150° C. and a suitable austenite finish temperature is about −130° C. for an actuator comprised of nitinol. To achieve transforms at these temperatures, a standard nitinol alloy can be modified by the addition of a third element, such as iron or chromium.

In order to have the temperature alert reset upon immersion in LN2, the martensite finish temperature should be above −196° C. A suitable martensite start temperature would be about −180° C. Lower martensite finish temperatures of at least −269° C. can be used if liquid helium is used to reset.

### Suitable Materials for Biological Specimens

Biological specimens, such as human reproductive cells, may come in contact with various components of a cryocontainer. Human reproductive cells are negatively sensitive to certain materials. Materials that do not cause such a reaction are called “non-embryotoxic.” Thus, suitable materials for the cryocontainer tube, cylindrical base, and alert rod include non-embryotoxic materials suitable for cryogenic service. Ionomer resins such a Surlyn 8921 are suitable. Our tests have shown that nitinol is non-embryotoxic according to standardized tests and therefore is suitable as well. Nitinol can be used at cryogenic temperatures.

### Method to Warn of Imminent Devitrification During Inspection

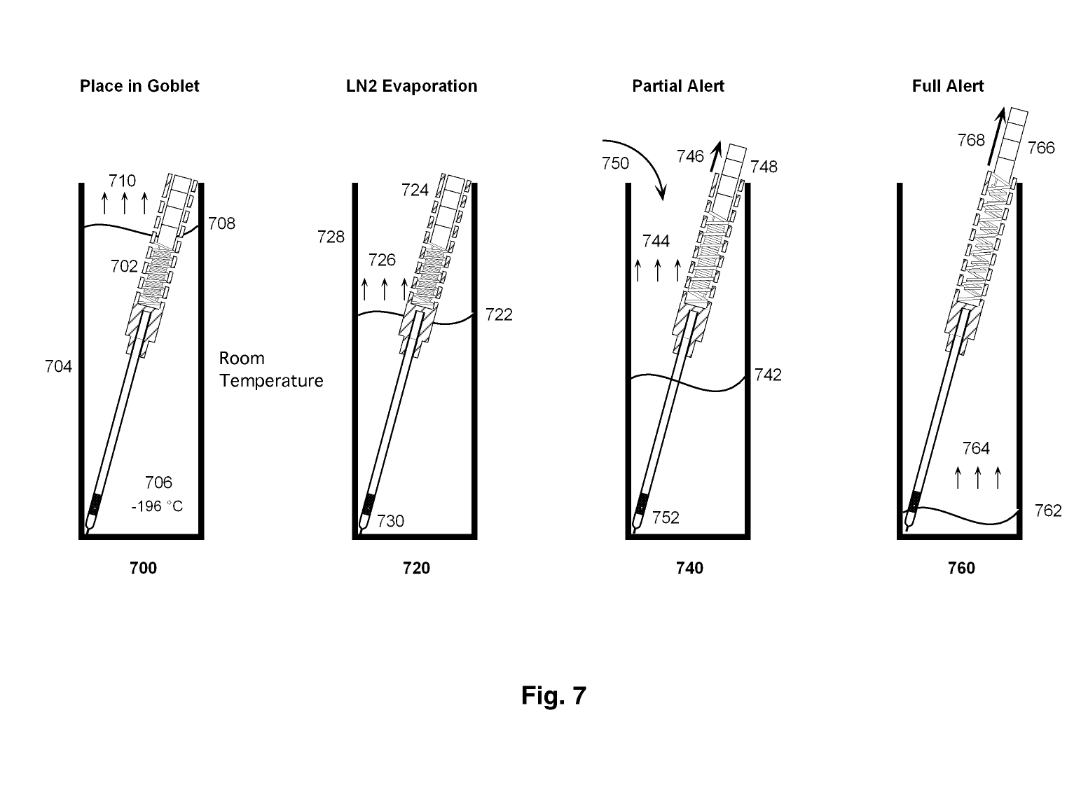

FIG. 7 illustrates how the temperature alert device can alert a user of a devitrification risk after a cryocontainer is removed from long term storage for inspection. Referring to item 700, a cryocontainer 702 is taken out of long-term storage for inspection and placed in a small container 704 of LN2 706. These containers are commonly referred to as “goblets”. The goblet is filled with LN2 to level 708 near the top. As the LN2 absorbs ambient heat, it boils off to form a vapor 710.

Referring to item 720, as inspection proceeds, the level 722 of LN2 in the goblet falls due to LN2 boil-off. The temperature alert device 724 has not initiated an alert since the boiled-off nitrogen vapor 726 surrounding the actuator is still colder than −150° C. The vapor warms principally by absorbing ambient heat through the goblet's walls 728. The distal end 730 of the cryocontainer that houses the biological specimen is still immersed in quite a bit of LN2, a safe situation.

Item 740 shows further LN2 level 742 decrease. The temperature of the vapor 744 surrounding the actuator is warm enough to register transform motion 746 and extend the alert rod 748. In addition to the heating from the goblet's walls, the vapor may also be warmed due to swirls 750 of ambient air that mix in with the boiled-off LN2 vapors. The alert rod moves partially out the cylindrical chamber to signal an alert. However, the distal end of the cryocontainer 752 is still immersed in LN2 and the biological specimen is in no danger of devitrification. Therefore, the alert 746, conservatively provides an “early warning” of a devitrification risk. In a room full of inspection goblets, it is a burden to peer into each to observe the LN2 level. At a glance, the user can visually infer the LN2 level in each goblet and intervene if necessary.

Item 760 illustrates further LN2 boil-off that leaves the biological specimen barely immersed in LN2 762. The vapor's 764 temperature has increased such that the actuator's transform motion has reached its limit. The alert rod 766 extends fully 768 and the cryocontainer is now at full alert. Technicians know to take immediate action to refill the goblet with LN2 or return the cryocontainer to long term storage.

It is possible that the user removes the cryocontainer from long-term storage and places it in a goblet without LN2. In this scenario, the cryocontainer may not have its “early warning” feature as described above. But because the actuator's austenite start temperature is warmer than the T_{g} of water, the cryocontainer will initiate an alert well before the T_{g} and provide increasingly stronger alerts as T_{g} is approached.

After an alert, placing the cryocontainer back into LN2 resets the temperature alert device. The chilling effect of this cryogen invokes transform motion that retracts the alert rod back into the cylindrical chamber. With this temperature alert device, inspection procedures may be modified to record the position of the alert rod before the cryocontainer is reimmersed in LN2. This memorializes the safe handling of the biological specimen during inspection.

The temperature alert device provides a visual alert of a devitrification risk. Transform motion can also be used in different ways to communicate the alert. Example would be flashing lights, an audible alarm, or wirelessly such as with an RFID tag.

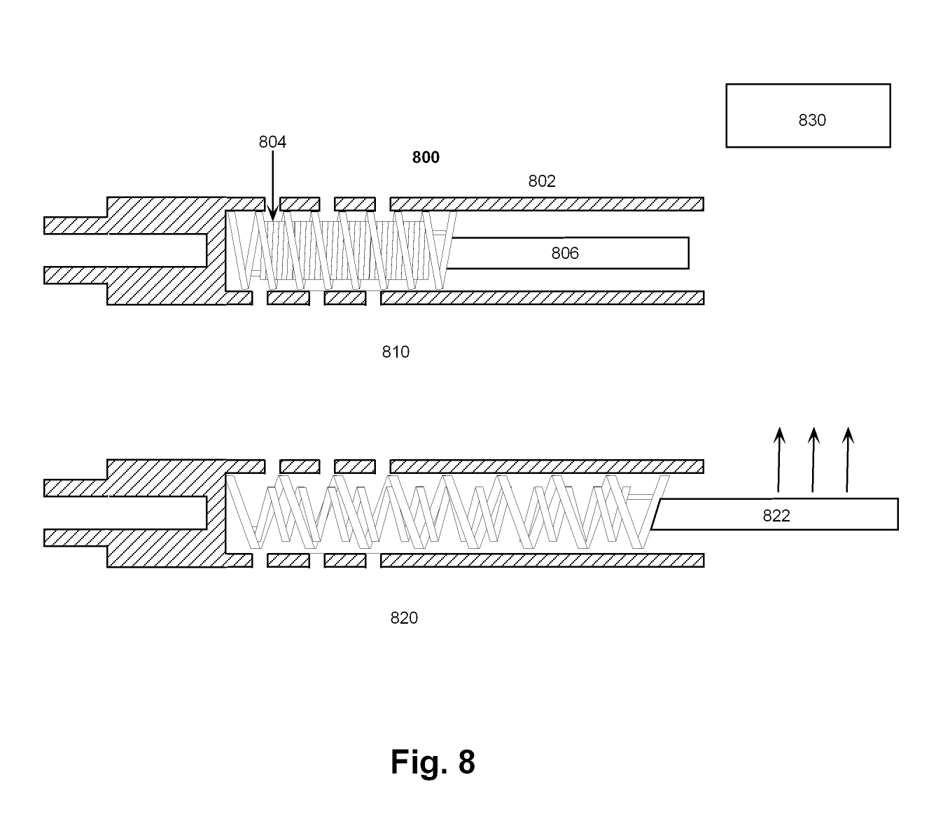

FIG. 8 illustrates a temperature alert device modified for inclusion of an RFID tag. The alert device 800 comprises a modified cylindrical base 802, a shape memory actuator 804, and an RFID tag 806. When the temperature alert device is cold 810, the shape memory actuator is collapsed and the RFID tag is withdrawn into the modified cylindrical base. The modified cylindrical base electromagnetically shields the RFID tag from an external RFID reader 830 and so the RFID tag is not “visible” to the reader. When the temperature alert device warms 820, however, the shape memory actuator expands and the RFID tag 822 moves out of the chamber and becomes “visible” to the RFID reader. A warning may then be sounded.

### Design Considerations

The temperature alert device described herein can be used in open and closed vitrification cryocontainers. The early warning feature of this invention is related to the distance between the actuator and the biological specimen. This distance can be modified to the needs of users who may utilize goblets of varying sizes. Actuators using one-way nitinol without a bias spring can be used to fabricate a temperature alert device. These actuators will not have the automatic reset feature. They can be reset by pushing the alert rod back into the cylindrical chamber after the actuator has been transformed to martensite.

### Conclusion

While the disclosure has been described with reference to one or more different exemplary embodiments, it will be understood by those skilled in the art that various changes may be made and equivalents may be substituted for elements thereof without departing from the scope of the disclosure. In addition, many modifications may be made to adapt to a particular situation without departing from the essential scope or teachings thereof. Therefore, it is intended that the disclosure not be limited to the particular embodiment disclosed as the best mode contemplated for carrying out this invention.

1. A temperature alert device for warning of devitrification danger, said device comprising:
a. a shape memory element;
b. a chamber; and
c. an alert rod residing at least partially within said chamber,
wherein said alert rod is operatively engaged with said shape memory element such that said alert rod is urged at least partially out of said chamber if the temperature of said chamber is above a first threshold warming temperature.

2. The temperature alert device of claim 1 in which the shape memory element is a spring.

3. The temperature alert device of claim 2 further comprising a bias spring attached to said shape memory spring to form an actuator such that said alert rod is urged into said chamber to a reset position when the temperature of said chamber is below a chilling threshold value.

4. The temperature alert device of claim 3 wherein said shape memory spring is a nitinol alloy which has a martensite finish temperature greater than or equal to −196° C. and an austenite finish temperature less than or equal to −130° C.

5. The temperature alert device of claim 2 wherein said shape memory spring comprises a two-way shape memory alloy and wherein the memorized shape of the martensite phase of said shape memory spring is shorter than the memorized shape of the austenite phase of said shape memory spring.

6. The temperature alert device of claim 1 wherein said alert rod is a tab or cylinder.

7. The temperature alert device of claim 1 in which the maximum movement of said alert rod out of said chamber is reached said temperature alert device is warmed to a second threshold temperature.

8. The temperature alert device of claim 7 wherein said second threshold temperature is about −130° C.

9. The temperature alert device of claim 1 wherein said alert rod comprises an RFID tag.

10. A cryocontainer for the vitrification of a biological specimen, said cryocontainer comprising:
a. a tube for holding a biological specimen; and
b. a temperature alert device,
said temperature alert device comprising a shape memory actuator such that said temperature alert device will provide first indication at about −150° C., intermediary indications above −150° C., and a final indication at about −130° C.

11. The cryocontainer of claim 10 wherein said temperature alert device will automatically reset upon immersion in liquid nitrogen.

12. The cryocontainer of claim 10 wherein said temperature alert device further comprises an alert rod and said indications of temperature correspond to degrees of linear movement of said alert rod with respect to said tube.

13. A method for reducing the chance of devitrification of a biological specimen during inspection, said method comprising the steps of:
a. placing a cryocontainer holding said sample in a goblet containing a cryogenic fluid, said cryocontainer comprising a temperature alert device, said temperature alert device being configured to respond when it warms above a first threshold temperature;
b. monitoring said temperature alert device to detect said response; and
c. taking a specific action to reduce the chance of devitrification when said monitoring detects said response.

14. The method of claim 13 wherein said first threshold temperature is in the range of −150° C. to −130° C.

15. The method of claim 13 wherein said response is the revealing of a color.

16. The method of claim 13 wherein said response is the triggering of an RFID reader.

17. The method of claim 13 wherein said specific action is to add additional cryogenic fluid to said goblet.

18. The method of claim 13 wherein said specific action is to move said cryocontainer to long term cryogenic storage.

19. The method of claim 13 wherein said cryogenic fluid is liquid nitrogen.
